(19) United States
(12) Patent Application Publication
(10) Pub. No.: US 2020/0037010 A1
(43) Pub. Date: Jan. 30, 2020

(54) INTELLIGENT CONTENT ADJUSTMENT IN LIVE STREAMING

(71) Applicant: International Business Machines Corporation, Armonk, NY (US)

(72) Inventors: Kelley Anders, East New Market, MD (US); Jonathan Dunne, County Waterford (IE); Jeremy R. Fox, Georgetown, TX (US); Liam S. Harpur, Skerries (IE)

(73) Assignee: International Business Machines Corporation, Armonk, NY (US)

(21) Appl. No.: 16/045,659

(22) Filed: Jul. 25, 2018

(51) Int. Cl. H04N 21/234; H04N 21/2187; H04N 21/258; H04N 21/845

(52) U.S. Cl. CPC H04N 21/23424; H04N 21/2187; H04N 21/845; H04N 21/25891; H04N 21/23418

(57) ABSTRACT

From a user's content viewing history, a set of factor values are constructed that are representative of an expected content type associated with the user. A live streaming of a main content is analyzed, using a processor and a memory, to forecast a first period during which a probability of an occurrence of expected content type is below a threshold. During the first period, a secondary content is substituted in the live streaming of the main content. The secondary content is an adjustment of the main content. After the first period is concluded, the live streaming of the main content continues.

### TECHNICAL FIELD

The present invention relates generally to a method, system, and computer program product for video streaming. More particularly, the present invention relates to a method, system, and computer program product for intelligent content adjustment in live streaming.

### BACKGROUND

Many consumers enjoy watching video content streamed to consumers' devices over a communications network such as the Internet. Users often form viewing habits—for example, related to specific times or specific contexts in users' lives. For example, one user often watches content related to cooking on Saturday afternoons, while another watches content related to animals on Saturday mornings. A third user often watches online presentations on the same evenings the user attends a local presentation club group.

Streamed video content may be “live” or pre-recorded. Live video is not available in toto in advance, but instead is streamed to viewers as it occurs. For example, sporting events are often streamed live, while scripted dramas are often recorded and made available for streaming at a later time.

### SUMMARY

The illustrative embodiments provide a method, system, and computer program product. An embodiment includes a method that constructs, from a user's content viewing history, a set of factor values that are representative of an expected content type associated with the user. The embodiment analyzes, using a processor and a memory, a live streaming of a main content to forecast a first period during which a probability of an occurrence of expected content type is below a threshold. The embodiment substitutes, during the first period, a secondary content in the live streaming of the main content, the secondary content comprising an adjustment of the main content. The embodiment continues the live streaming of the main content after the first period is concluded.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example configuration for intelligent content adjustment in live streaming in accordance with an illustrative embodiment;

FIG. 4 depicts a flowchart of part of an example process for intelligent content adjustment in live streaming in accordance with an illustrative embodiment; and

FIG. 5 depicts a flowchart of part of an example process for intelligent content adjustment in live streaming in accordance with an illustrative embodiment.

### DETAILED DESCRIPTION

Live content, by its nature, allows the provider of that content little or no time to screen the content in advance and categorize content appropriately. Without such categorization a viewer will have difficulty deciding whether the content includes something the viewer does not want to see. For example, one content viewer might prefer not to see blood, while another might want to avoid viewing content related to travel.

In addition to categorizing content, a content provider or viewer might want to adjust the content to avoid objectionable material. For example, commercially available products may filter pre-recorded content to skip playing of objectionable scenes. However, because there is little time to screen live content in advance to determine the presence of objectionable content, adjusting to avoid objectionable material becomes more difficult.

However, not all users object to the same types of content. For example, one user might not want to see content of type A (e.g., tragedy dramas, suitable for all ages). Another user might prefer content of type A, but avoid content of type B (e.g., violence, suitable for ages 17 and up). Further, users often find that supplying detailed preference information is time consuming and insufficiently granular.

As well, users may find some content objectionable at some times and not at other times. For example, some content is suitable for young children and other content is not. On a weekend morning with children present, a user might object to any content that is not suitable for young children. Another user might watch some content to prepare for a work event, but finds that content boring and prefers not to watch further once the work event is over.

The illustrative embodiments recognize that the presently available tools or solutions do not address these needs or provide adequate solutions for these needs. The illustrative embodiments used to describe the invention generally address and solve the above-described problems and other problems related to intelligent content adjustment in live streaming.

An embodiment can be implemented as a software application. The application implementing an embodiment can be configured as a modification of an existing live main content transmission system, as a separate application that operates in conjunction with an existing live main content transmission system, a standalone application, or some combination thereof.

Particularly, some illustrative embodiments provide a method by which it can be determined whether content a user is not expecting is likely to occur during a future period in the main content transmission, and insert secondary content—an adjusted version of the main content—during that period.

An embodiment determines content a user is expecting based on the user's content viewing history. An embodiment learns a user's content viewing history by monitoring content, including live streams, viewed by the user over time.

An embodiment analyzes a piece of video content, producing a set of metadata describing that particular video and associated audio content. An embodiment can analyze content as a user views it, or at an earlier or later time. The set of metadata includes keywords, for example entities such as people, cities, and organizations, referenced in the content, as well as specific items recognized in the content, such as objects, celebrity faces, and food. The set of metadata also includes higher-level concepts, themes, and sentiment and emotion information related to the content. These are non-limiting examples, and the set of metadata can also include additional information obtained by analyzing the piece of video content without departing from the scope of the embodiments.

From the metadata, an embodiment categorizes each piece of video content to a content type. Some examples of content types include but are not limited to cooking, travel, home renovation, violence, and the like.

An embodiment uses the categorized content in a user's content viewing history to construct a set of factor values. The factor values, when taken together, represent an expected content type associated with the user. One factor represents the type of content currently being watched, and another factor represents a type of content the user has watched previously. For example, the categorized content may show that one user often watches cooking content, while another user often watches online presentations. Thus, when the first user is watching content that includes images of food and is known to have watched cooking content previously, both factors help the embodiment determine that this user is currently watching cooking content and expects upcoming content in the live stream to also contain cooking content. Similarly, when the second user is watching content including images of a person on a stage accompanied by slides, and this user is known to watch online presentations, both factors help the embodiment determine that this user is currently watching an online presentation and expects upcoming content in the live stream to also contain content related to an online presentation. The set of factor values can be determined using, for example, linear discriminant analysis, discriminant cluster analysis, or any other suitable technique known to those of ordinary skill in the art.

One factor value in the set of factor values can be associated with the time at which a user viewed the content. For example, a user might typically watch cooking content on Saturday afternoons, but other content at different times. Here, when this user is watching content that includes images of food, he or she is known to watch cooking content, and it is Saturday afternoon, the embodiment can determine that the user is currently watching cooking content and expects upcoming content in the live stream to also contain cooking content. However, if it is not Saturday afternoon, the user might be watching some other type of content that happens to include food images, such as a travel show, and any conclusion regarding expected content will be less reliable.

Another factor in the set of factor values can be associated with the context within which a user viewed the content. For example, a user might typically watch online presentations on the same evenings the user attends a local presentation club group, but other content at different times. Here, when this user is watching content that includes images of a person on a stage accompanied by slides, and the user's calendar indicates that this is a presentation club evening, the embodiment can determine that the user is currently watching an online presentation and expects upcoming content in the live stream to be similar. However, if it is not a presentation club evening, the user might be watching some other type of content, and any conclusion regarding expected content will be less reliable.

A third factor in the set of factor values can be associated with the viewing history of similar users. For example, if a user does not have a sufficiently detailed or sufficiently long viewing history to assist with determining an expected content type, an embodiment matches that user's characteristics with groups of users having similar characteristics, and uses the group's viewing history to supplement the user's viewing history. For example, if a new user is watching content that includes images of food and he or she resembles a group of users that mostly watches cooking content, this user is likely to be watching, and expecting to continue watching, cooking content as well.

An embodiment determines a user's viewing history, calendar, and other information related to other users with similar characteristics through, for example, the user's profile on a content viewing platform, associating the user with a social media profile or other online activity, or by any other suitable means.

An embodiment employs a known forecasting algorithm in a known forecasting engine to analyze a live stream and forecast upcoming content in the live stream and the duration of that upcoming content. For example, if a live telecast of a tragic play is ongoing, the embodiment determines a probability P that within the next S seconds of the ongoing telecast, a dramatic soliloquy of length L seconds will take place. Similarly, if a live telecast of a cooking demonstration is ongoing, the embodiment determines a probability P that within the next S seconds of the ongoing telecast, a scene showing the gutting of a fish, lasting L seconds, will be shown.

The embodiment uses the set of factor values—indicating a content type the user is expecting—to predict whether upcoming content in the live stream is likely to match the user's expectations. When the probability of the user's expected content type falls below a threshold, the embodiment concludes that a period of unexpected content has been identified in the forecasting period. For example, if the user is watching cooking content, he or she expects that upcoming portions of the live stream will continue to relate to cooking. However, if blood or a dramatic soliloquy are forecasted to be upcoming instead, this is unexpected content the user likely would not want to see.

The embodiment inserts secondary content—an adjusted version of the main content—during that period of unexpected content, on the fly as the main content is received and analyzed. To adjust the content, the embodiment removes some or all portions of the contents of one unit of content (e.g. a video frame), replaces some or all portions of the contents of one unit of content with a predetermined replacement content (e.g., black pixels), changes some or all portions of the contents of one unit of content (e.g., a sharp image to a blurry image), adds additional content to some or all portions of the contents of one unit of content (e.g., adding a highlight indicator in a frame, generating a pop-up dialog, overlaying a text-box), or some combination thereof. An embodiment also determines the nature of the adjustment from the user's history or viewing profile. For example, one user might set a preference for a blurring adjustment, while another might prefer a black screen. Once the embodiment determines that the period of unexpected content is complete, the embodiment continues the live streaming of the main content.

Streaming of live content is a well-recognized technological field of endeavor. Presently available methods do not allow content adjustment in live streaming, while the live content is being streamed or delivered to a user, based on learned details of the user's viewing history. The manner of intelligent content adjustment in live streaming described herein is unavailable in the presently available methods. A method of an embodiment described herein, when implemented to execute on a device or data processing system, comprises substantial advancement of the functionality of that device or data processing system in intelligently adjusting unexpected content in a live transmission of a main content based on the viewer's content viewing history.

The illustrative embodiments are described with respect to certain types of contents, content types, transmissions, periods, forecasts, thresholds, adjustments, measurements, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

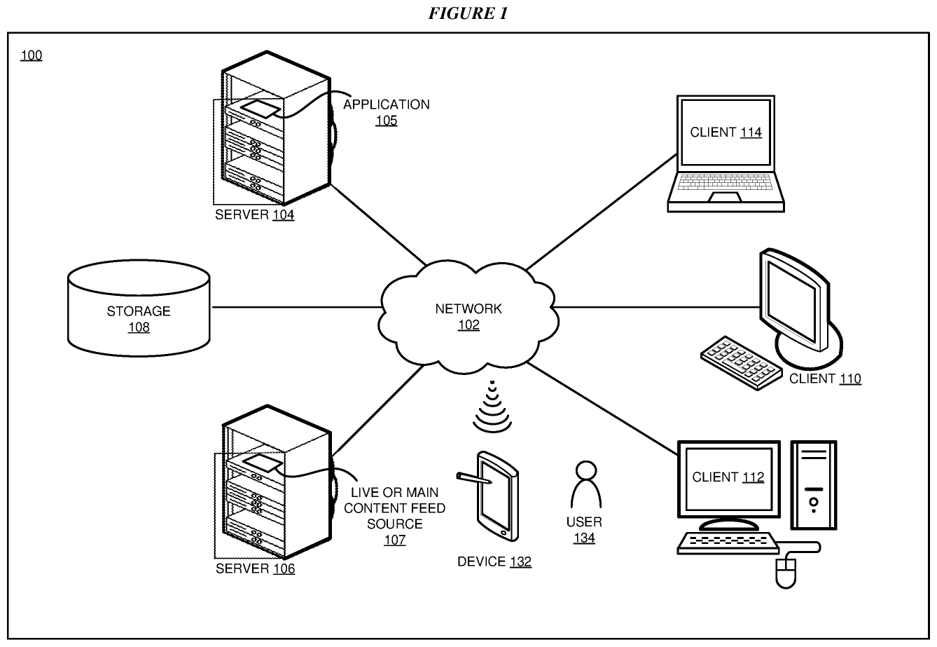

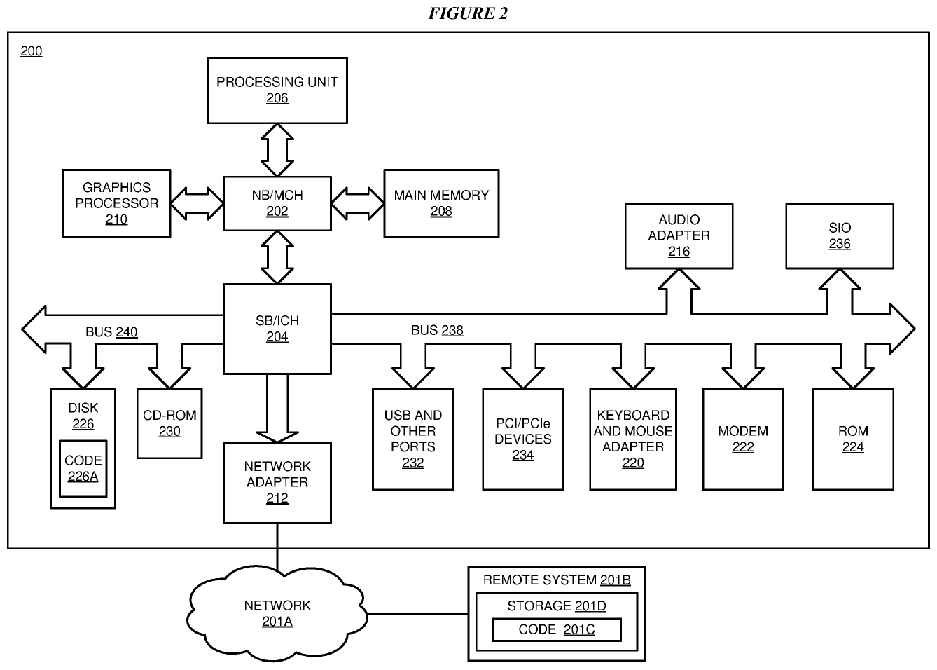

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Application 105 implements an embodiment described herein. Example source 107 provides the main content for a live stream or transmission. As an example, user 134 may receive the live stream of the main content on device 132.

Servers 104 and 106, storage unit 108, and clients 110, 112, and 114, and device 132 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications. Data processing environment 100 may also take the form of a cloud, and employ a cloud computing model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as application 105 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. In another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

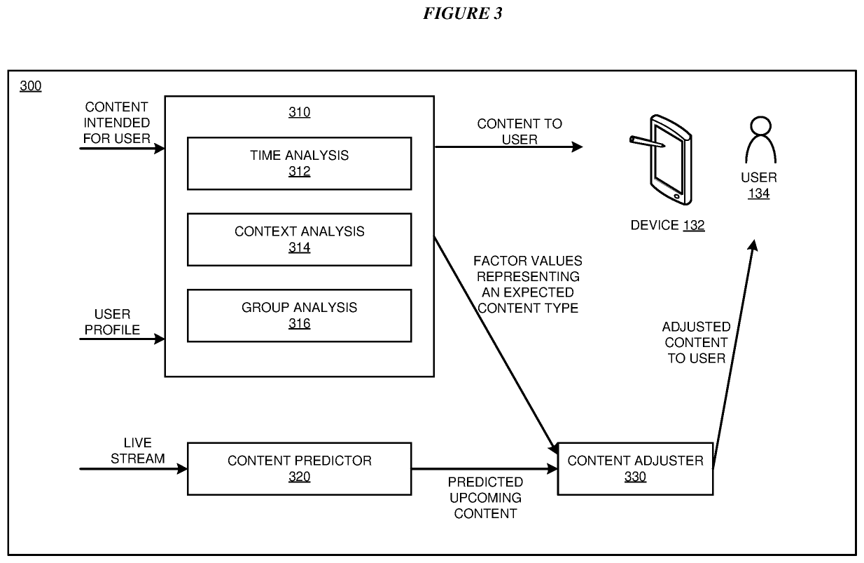

With reference to FIG. 3, this figure depicts a block diagram of an example configuration for intelligent content adjustment in live streaming in accordance with an illustrative embodiment. Application 300 is an example of application 105 in FIG. 1.

Content feeds into history analysis module 310, which determines content a user is expecting based on the user's content viewing history. In particular, history analysis module 310 analyzes incoming video content, producing a set of metadata describing each piece of video and associated audio content and categorizing each piece of content to a content type. History analysis module 310 uses the categorized content to construct a set of factor values that are representative of an expected content type associated with a user. History analysis module 310 also passes along content, as it is received, for user 134 to view on device 132. User 134 and device 132 are the same as user 134 and device 132 in FIG. 1.

If available, history analysis module 310 can also take into account a user's calendar, and information related to other users with similar characteristics when constructing the set of factor values. Within history analysis module 310, time analysis module 312 determines a factor value associated with the time at which user 134 viewed the content. Context analysis module 314 determines a factor value associated with a context within which user 134 viewed the content. Group analysis module 316 determines a factor value associated with a group of users having similar characteristics to user 134. Time analysis module 312, context analysis module 314, and group analysis module 316 are all optional. Once determined, history analysis module 310 sends the set of factor values to content adjuster 330.

A live stream of main content is obtained from source 107 in FIG. 1 and feeds into content predictor 320. Content predictor 320 employs a known forecasting algorithm in a known forecasting engine to analyze the live stream and forecast upcoming content and the duration of that upcoming content.

Content adjuster 330 uses the set of factor values representative of an expected content type from history analysis module 310 and the predicted upcoming content from content predictor 320 to predict whether upcoming content in the live stream is likely to match the user's expectations. When the likelihood of the user's expected content type falls below a threshold likelihood, content adjuster 330 concludes that a period of unexpected content has been identified in the forecasting period and inserts secondary content—an adjusted version of the main content—during that period of unexpected content. Once content adjuster 330 determines that the period of unexpected content is complete, content adjuster 330 continues the live streaming of the main content.

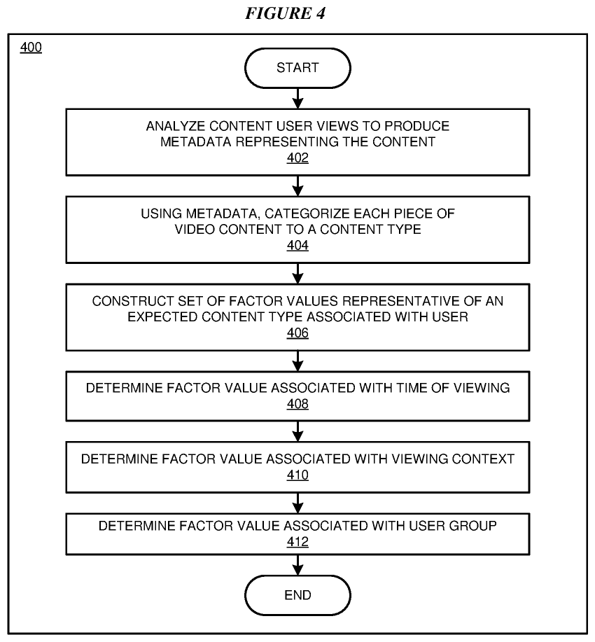

FIG. 4 depicts a flowchart of part of an example process for intelligent content adjustment in live streaming in accordance with an illustrative embodiment. Process 400 can be implemented in application 300 in FIG. 3.

Over time, as a user views content, the application analyzes each piece of content, producing a set of metadata describing that particular video and associated audio content (block 402). From the metadata, the application categorizes each piece of video content to a content type (block 404). Using these categorizations, the application constructs a set of factor values that are representative of an expected content type associated with the user (block 406). In block 408, the application optionally determines a factor value associated with the time at which the user viewed the content. The application optionally determines (block 410) a factor value associated with a context within which the user viewed the content. The application also optionally determines (block 412) a factor value associated with a group of users having similar characteristics to the user.

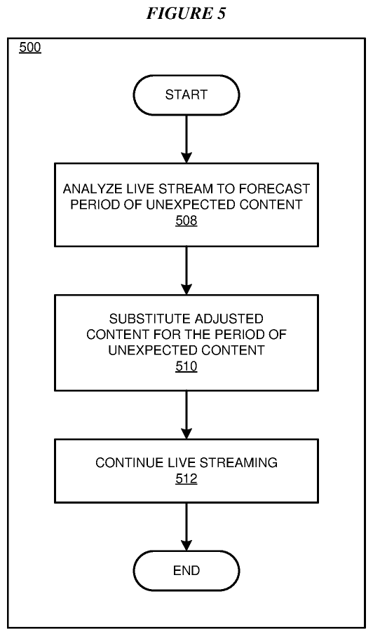

FIG. 5 depicts a flowchart of part of an example process for intelligent content adjustment in live streaming in accordance with an illustrative embodiment. Process 500 can be implemented in application 300 in FIG. 3, and uses the per-user factor values determined by application 400 in FIG. 4. In block 508, application 500 employs a known forecasting algorithm in a known forecasting engine to analyze the live stream and forecast upcoming content and the duration of that upcoming content, then uses the set of factor values and the predicted upcoming content to predict whether upcoming content in the live stream is likely to match the user's expectations. When the likelihood of the user's expected content type falls below a threshold likelihood, (block 510) the application concludes that a period of unexpected content has been identified in the forecasting period and inserts secondary content—an adjusted version of the main content—during that period of unexpected content. Once the period of unexpected content is complete, the application (block 512) continues the live streaming of the main content.

Thus, a computer implemented method, system or apparatus, and computer program product are provided in the illustrative embodiments for intelligent content adjustment in live streaming and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
constructing, from a user's content viewing history, a set of factor values that are representative of an expected content type associated with the user;
analyzing, using a processor and a memory, a live streaming of a main content to forecast a first period during which a probability of an occurrence of expected content type is below a threshold;
substituting, during the first period, a secondary content in the live streaming of the main content, the secondary content comprising an adjustment of the main content; and
continuing the live streaming of the main content after the first period is concluded.

2. The method of claim 1, wherein constructing the set of factor values further comprises:
constructing, based on a first content viewed by a user, a first set of metadata representing the first content;
constructing, based on a second content viewed by a user, a second set of metadata representing the second content;
computing, based on the first set of metadata, a first content type associated with the first content;
computing, based on the second set of metadata, a second content type associated with the second content; and
constructing the set of factor values based on the first content type and the second content type.

3. The method of claim 2, wherein the set of factor values further comprises:
a factor value associated with the time at which the user viewed the first content.

4. The method of claim 2, wherein the set of factor values further comprises:
a factor value associated with the context within which the user viewed the first content.

5. The method of claim 2, wherein the set of factor values further comprises:
a factor value associated with a group of users having similar characteristics to the user.

6. The method of claim 1, wherein the adjustment of the main content comprises a blurring of the main content.

7. The method of claim 1, wherein the adjustment of the main content comprises replacing a portion of the main content with a black area.

8. A computer usable program product comprising one or more computer-readable storage devices, and program instructions stored on at least one of the one or more storage devices, the stored program instructions comprising:
program instructions to construct, from a user's content viewing history, a set of factor values that are representative of an expected content type associated with the user;
program instructions to analyze, using a processor and a memory, a live streaming of a main content to forecast a first period during which a likelihood of an occurrence of expected content type is below a threshold likelihood;
program instructions to substitute, during the first period, a secondary content in the live streaming of the main content, the secondary content comprising an adjustment of the main content; and
program instructions to continue the live streaming of the main content after the first period is concluded.

9. The computer usable program product of claim 8, wherein program instructions to construct the set of factor values further comprises:
program instructions to construct, based on a first content viewed by a user, a first set of metadata representing the first content;
program instructions to construct, based on a second content viewed by a user, a second set of metadata representing the second content;
program instructions to compute, based on the first set of metadata, a first content type associated with the first content;
program instructions to compute, based on the second set of metadata, a second content type associated with the second content; and
program instructions to construct the set of factor values based on the first content type and the second content type.

10. The computer usable program product of claim 9, wherein the set of feature values further comprises:
a factor value associated with the time at which the user viewed the first content.

11. The computer usable program product of claim 9, wherein the set of feature values that are representative of an expected content type further comprises:
a factor value associated with the context within which the user viewed the first content.

12. The computer usable program product of claim 9, wherein the set of feature values further comprises:
a factor value associated with a group of users having similar characteristics to the user.

13. The computer usable program product of claim 8, wherein the adjustment of the main content comprises a blurring of the main content.

14. The computer usable program product of claim 8, wherein the adjustment of the main content comprises replacing a portion of the main content with a black area.

15. The computer usable program product of claim 8, wherein the computer usable code is stored in a computer readable storage device in a data processing system, and wherein the computer usable code is transferred over a network from a remote data processing system.

16. The computer usable program product of claim 8, wherein the computer usable code is stored in a computer readable storage device in a server data processing system, and wherein the computer usable code is downloaded over a network to a remote data processing system for use in a computer readable storage device associated with the remote data processing system.

17. A computer system comprising one or more processors, one or more computer-readable memories, and one or more computer-readable storage devices, and program instructions stored on at least one of the one or more storage devices for execution by at least one of the one or more processors via at least one of the one or more memories, the stored program instructions comprising:
program instructions to construct, from a user's content viewing history, a set of factor values that are representative of an expected content type associated with the user;
program instructions to analyze, using a processor and a memory, a live streaming of a main content to forecast a first period during which a likelihood of an occurrence of expected content type is below a threshold likelihood;
program instructions to substitute, during the first period, a secondary content in the live streaming of the main content, the secondary content comprising an adjustment of the main content; and
program instructions to continue the live streaming of the main content after the first period is concluded.

18. The computer system of claim 17, wherein program instructions to construct the set of factor values further comprises:
program instructions to construct, based on a first content viewed by a user, a first set of metadata representing the first content;
program instructions to construct, based on a second content viewed by a user, a second set of metadata representing the second content;
program instructions to compute, based on the first set of metadata, a first content type associated with the first content;
program instructions to compute, based on the second set of metadata, a second content type associated with the second content; and
program instructions to construct the set of factor values based on the first content type and the second content type.

19. The computer system of claim 18, wherein the set of feature values further comprises:
a factor value associated with the time at which the user viewed the first content.

20. The computer system of claim 18, wherein the set of feature values that are representative of an expected content type further comprises:
a factor value associated with the context within which the user viewed the first content.
